(19) United States
(12) Patent Application Publication
(10) Pub. No.: US 2016/0011351 A1
(43) Pub. Date: Jan. 14, 2016

(54) IMAGE DISPLAY DEVICE

(71) Applicant: NITTO DENKO CORPORATION, Ibaraki-shi, Osaka (JP)

(72) Inventors: Hiroshi Tomohisa, Ibaraki-shi (JP); Shouichi Matsuda, Ibaraki-shi (JP); Hiroyuki Takemoto, Ibaraki-shi (JP); Tadayuki Kameyama, Ibaraki-shi (JP)

(73) Assignee: NITTO DENKO CORPORATION, Ibaraki-shi, Osaka (JP)

(21) Appl. No.: 14/770,951

(22) PCT Filed: Mar. 5, 2014
(86) PCT No.: PCT/JP2014/055574

§ 371 Date: Aug. 27, 2015

(30) Foreign Application Priority Data
Mar. 6, 2013 (JP) 2013-044593
Mar. 4, 2014 (JP) 2014-041472

(51) Int. Cl. G02B 5/30; G02B 5/08

(52) U.S. Cl. CPC G02B 5/3041; G02B 5/3083; G02B 5/0808

(57) ABSTRACT

There is provided an image display apparatus having high contrast and making it difficult to visually observe its conductive pattern despite including a metal nanowire or a metal mesh. An image display apparatus of the present invention includes: a circularly polarizing plate, a transparent conductive film, and a display element comprising a reflector made of a metal in the stated order from a viewer side, wherein: the transparent conductive film comprises a transparent base material and a transparent conductive layer arranged on at least one side of the transparent base material; the transparent base material has an in-plane retardation Re of from 1 nm to 100 nm; and the transparent conductive layer comprises a metal nanowire or a metal mesh.

### TECHNICAL FIELD

The present invention relates to an image display apparatus.

### BACKGROUND ART

A transparent conductive film obtained by forming a metal oxide layer such as an indium-tin composite oxide (ITO) layer on a transparent resin film has heretofore been frequently used as an electrode for a touch sensor in an image display apparatus including the touch sensor. However, the transparent conductive film including the metal oxide layer involves a problem in that it is difficult to use the film in applications where bending resistance is required such as a flexible display because the conductivity of the film is liable to be lost by its bending.

Meanwhile, a transparent conductive film including a metal nanowire or a metal mesh has been known as a transparent conductive film having high bending resistance. However, the transparent conductive film involves a problem in that ambient light is reflected and scattered by the metal nanowire or the like. When such transparent conductive film is used in an image display apparatus, the following problem occurs. The pattern of the metal nanowire or the like is visually observed and the contrast of the apparatus reduces, and hence its display characteristics become poor.

### CITATION LIST

### Patent Literature

[PTL 1] JP 2004-349061 A

[PTL 2] JP 2010-243769 A

[PTL 3] JP 2012-009359 A

### SUMMARY OF INVENTION

### Technical Problem

The present invention has been made to solve the problems, and an object of the present invention is to provide an image display apparatus having high contrast and making it difficult to visually observe its conductive pattern despite including a metal nanowire or a metal mesh.

### Solution to Problem

An image display apparatus of the present invention includes: a circularly polarizing plate, a transparent conductive film, and a display element comprising a reflector made of a metal in the stated order from a viewer side, wherein: the transparent conductive film comprises a transparent base material and a transparent conductive layer arranged on at least one side of the transparent base material; the transparent base material has an in-plane retardation Re of from 1 nm to 100 nm; and the transparent conductive layer comprises a metal nanowire or a metal mesh.

In one embodiment of the present invention, the circularly polarizing plate comprises a retardation film and a polarizer; and the circularly polarizing plate is arranged so that the polarizer is on the viewer side.

In one embodiment of the present invention, in a portion in the image display apparatus where the circularly polarizing plate and the transparent conductive film are laminated, a diffuse reflectance is reduced by 90% or more.

In one embodiment of the present invention, the transparent conductive layer is patterned.

In one embodiment of the present invention, the metal nanowire comprises one or more kinds of metals selected from the group consisting of gold, platinum, silver, and copper.

### Advantageous Effects of Invention

According to the embodiment of the image display apparatus of the present invention, the circularly polarizing plate and the transparent conductive film are arranged so as to satisfy a specific relationship with respect to the display element including the reflector made of a metal, whereby the output of reflected light generated by the reflection of ambient light on the transparent conductive film can be suppressed. The output of the reflected light is suppressed, and hence even when a transparent conductive film including a metal nanowire or a metal mesh is used, the image display apparatus making it difficult to observe its conductive pattern (i.e., the pattern of the metal nanowire or the metal mesh) and having high contrast can be obtained.

### BRIEF DESCRIPTION OF DRAWINGS

FIG. 1 is a schematic sectional view of an image display apparatus according to a preferred embodiment of the present invention.

### DESCRIPTION OF EMBODIMENTS

A. Entire Construction of Image Display Apparatus

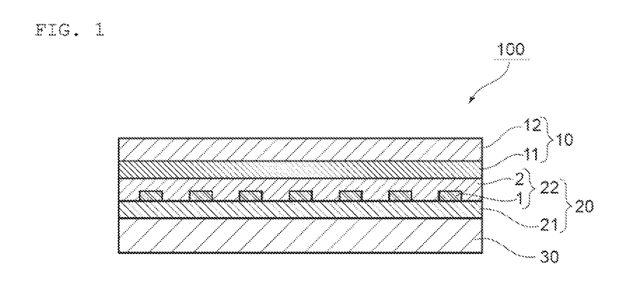

FIG. 1 is a schematic sectional view of an image display apparatus according to a preferred embodiment of the present invention. The image display apparatus 100 includes a circularly polarizing plate 10, a transparent conductive film 20, and a display element 30 in the stated order from a viewer side. The transparent conductive film 20 includes a metal nanowire 1. In the image display apparatus, the transparent conductive film 20 can function as, for example, an electrode for a touch panel or an electromagnetic wave shield. A display element including a reflector made of a metal is used as the display element 30. Such display element is typically, for example, an organic EL element including a reflective electrode (reflector). The use of the organic EL element as the display element can provide an image display apparatus excellent in bending resistance. It should be noted that the transparent conductive film 20, and the circularly polarizing plate 10 and/or the display element can be bonded to each other through any appropriate pressure-sensitive adhesive (not shown). In addition, the image display apparatus of the present invention may further include any appropriate other member depending on its applications and the like.

The transparent conductive film 20 includes a transparent base material 21 and a transparent conductive layer 22 arranged on at least one side of the transparent base material 21. When the transparent conductive layer is arranged on one side of the transparent base material, the transparent conductive layer may be arranged on the viewer side of the transparent base material, or may be arranged on a side opposite to the viewer side. The transparent conductive layer 22 is preferably arranged on the viewer side of the transparent base material 21 as illustrated in FIG. 1. The transparent conductive layer 22 includes the metal nanowire 1. The transparent conductive film 20 in this embodiment includes the transparent conductive layer 22 including the metal nanowire 1 and hence the film is excellent in bending resistance, and even when the film is bent, its conductivity is hardly lost. In one embodiment, the metal nanowire 1 may be protected with a protective layer 2 as illustrated in FIG. 1.

The transparent conductive layer may include a metal mesh instead of the metal nanowire or in combination with the metal nanowire. Details about the metal mesh are described later.

The image display apparatus of the present invention includes the circularly polarizing plate on a viewer side with respect to the display element including the reflector and the transparent conductive film. Accordingly, (i) ambient light (natural light) entering the circularly polarizing plate is transformed into circularly polarized light, (ii) the circularly polarized light is reflected on the reflector of the display element and the metal nanowire or metal mesh of the transparent conductive film to undergo the inversion of its circularly polarized state, and (iii) the inverted circularly polarized light does not pass the circularly polarizing plate and hence the output of the reflected ambient light from the image display apparatus can be prevented. In addition, when a transparent base material having a small in-plane retardation Re is used as the transparent base material constituting the transparent conductive film, after the (i), substantially no depolarization of the circularly polarized state occurs and hence the output of the reflected light can be significantly suppressed. The image display apparatus of the present invention reduced in ambient light reflection as described above has high contrast.

In a portion in the image display apparatus of the present invention where the circularly polarizing plate and the transparent conductive film are laminated, a diffuse reflectance is preferably reduced by 90% or more. A state in which the diffuse reflectance is reduced as described above can be quantitatively evaluated by a relationship between: a diffuse reflectance A measured by placing a laminate including the circularly polarizing plate and the transparent conductive film on a reflective plate made of aluminum for an evaluation, and causing predetermined light to enter the laminate and to be reflected thereon; and a diffuse reflectance B measured by causing the light to enter the reflective plate made of aluminum and to be reflected thereon. In this description, when the diffuse reflectance A and the diffuse reflectance B have a relationship of A≦(100%−X %)×B, it can be said that “in the portion in the image display apparatus where the circularly polarizing plate and the transparent conductive film are laminated, the diffuse reflectance is reduced by X % or more.” The relationship between the diffuse reflectance A and the diffuse reflectance B is preferably A≦0.1B. In addition, the relationship between the diffuse reflectance A and the diffuse reflectance B is more preferably A≦0.05B, still more preferably A≦0.03B. That is, in the portion in the image display apparatus of the present invention where the circularly polarizing plate and the transparent conductive film are laminated, the diffuse reflectance is more preferably reduced by 95% or more, and is still more preferably reduced by 97% or more. The image display apparatus reduced in scatter reflections as described above can be obtained by arranging the circularly polarizing plate on the viewer side with respect to the display element including the reflector and the transparent conductive film. A method of measuring a diffuse reflectance is described later.

in the present invention, the circularly polarizing plate is arranged on the viewer side with respect to the transparent conductive film including the metal nanowire or the metal mesh, whereby not only light reflected from the reflector of the display element but also light reflected from the metal nanowire or the metal mesh is reduced. Intrinsically, the metal nanowire or the metal mesh is responsible for an increase in reflectance. However, according to the present invention, even when the film includes the metal nanowire or the metal mesh, an increase in reflectance due to the metal nanowire or the metal mesh can be suppressed. As a result, a difference in light intensity between ambient light reflected on the metal nanowire or the metal mesh, and ambient light reflected on a portion except the metal nanowire or the metal mesh reduces, and hence an image display apparatus whose conductive pattern (i.e., the pattern of the metal nanowire or the metal mesh) is hardly observed can be obtained. A difference (A−C) between the diffuse reflectance A and a diffuse reflectance C measured by placing only the circularly polarizing plate on the reflective plate made of aluminum so that its polarizer may be arranged on an outer side is preferably 0.17% or less, more preferably 0.15% or less, still more preferably from 0.01% to 0.12%. A state in which the difference (A−C) is small means that the increase in reflectance due to the metal nanowire or the metal mesh is suppressed.

B. Circularly Polarizing Plate

The circularly polarizing plate 10 preferably includes a retardation film 11 and a polarizer 12. The circularly polarizing plate 10 is preferably arranged so that the polarizer 12 may be on the viewer side. For example, λ/4 plate is used as the retardation film. The circularly polarizing plate is formed by laminating the polarizer and the λ/4 plate so that an angle formed between the absorption axis of the polarizer and the slow axis of the λ/4 plate may be substantially 45° (e.g., from 40° to 50°). Practically, the circularly polarizing plate may have, on at least one side of the polarizer, a protective film for protecting the polarizer, though the film is not illustrated. The polarizer and the retardation film or the protective film can be laminated through intermediation of any appropriate adhesive or pressure-sensitive adhesive.

B-1. Polarizer and Protective Film

Any suitable polarizer is used as the polarizer. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dehydrochlorinated product of a polyvinyl chloride-based film. Of those, a polarizer prepared by adsorbing a dichromatic substance such as iodine on a polyvinyl alcohol-based film and uniaxially stretching the film is particularly preferred because of high polarized dichromaticity. The thickness of the polarizer is preferably from 0.5 μm to 80 μm.

The polarizer prepared by adsorbing iodine on a polyvinyl alcohol-based film and uniaxially stretching the film is typically produced by immersing a polyvinyl alcohol-based film in an iodine aqueous solution to dye the film and stretching the resultant film by from 3 to 7 times the original length. The film may be stretched after dyeing or during dyeing, or the film may be dyed after stretching. The polarizer is produced by subjecting the film to a treatment such as swelling, cross-linking, adjustment, washing with water, or drying in addition to the stretching and the dyeing.

Any appropriate film is used as the protective film. Specific examples of a material used as a main component of such film include a cellulose-based resin such as triacetylcellulose (TAC), and transparent resins such as a (meth)acrylic resin, a polyester-based resin, a polyvinyl alcohol-based resin, a polycarbonate-based resin, a polyimide-based resin, a polyimide-based resin, a polyether sulfone-based resin, a polysulfone-based resin, a polystyrene-based resin, a polynorbornene-based resin, a polyolefin-based resin, and an acetate-based resin. Another example thereof is a thermosetting resin or a UV-curable resin such as an acrylic resin, a urethane-based resin, an acrylic urethane-based resin, an epoxy-based resin, or a silicone-based resin. Still another example thereof is a glassy polymer such as a siloxane-based polymer. In addition, a polymer film described in JP 2001-343529 A (WO 01/37007 A1) may also be used. As a material for the film, there can be used a resin composition containing a thermoplastic resin having a substituted or unsubstituted imide group on its side chain and a thermoplastic resin having a substituted or unsubstituted phenyl group and a nitrile group on its side chain. An example thereof is a resin composition containing an alternate copolymer of isobutene and N-methylmaleimide and an acrylonitrile-styrene copolymer. The polymer film may be an extruded product of the resin composition, for example.

B-2. Retardation Film (λ/4 Plate)

The in-plane retardation Re of the λ/4 plate is preferably from 95 nm to 180 nm, more preferably from 110 nm to 160 nm. The λ/4 plate can transform linearly polarized light having a specific wavelength into circularly polarized light (or circularly polarized light into linearly polarized light). The λ/4 plate preferably has a refractive index ellipsoid of nx>ny≧nz. It should be noted that the in-plane retardation Re in this description refers to an in-plane retardation value at 23° C. and a wavelength of 590 nm. The Re is determined from the equation “Re=(nx−ny)×d” where nx represents a refractive index in the direction in which an in-plane refractive index becomes maximum (i.e., a slow axis direction), ny represents a refractive index in a direction perpendicular to a slow axis in a plane (i.e., a fast axis direction), and d (nm) represents the thickness of a film (e.g., the retardation film or a transparent base material to be described later). In addition, the term. “ny=nz” as used herein includes not only the case where ny and nz are strictly equal to each other but also the case where ny and nz are substantially equal to each other.

The λ/4 plate is preferably a stretched film of a polymer film. Specifically, the λ/4 plate is obtained by appropriately selecting the kind of a polymer and a stretching treatment (e.g., a stretching method, a stretching temperature, a stretching ratio, or a stretching direction).

Any appropriate resin is used as a resin forming the polymer film. Specific examples thereof include resins each constituting a positive birefringent such as a cycloolefin-based resin, e.g., polynorbornene, a polycarbonate-based resin, a cellulose-based resin, a polyvinyl alcohol-based resin, and a polysulfone-based resin. Of those, a norbornene-based resin or a polycarbonate-based resin is preferred.

The polynorbornene refers to a (co)polymer obtained by using a norbornene-based monomer having a norbornene ring as part or all of its starting materials (monomers). Examples of the norbornene-based monomer include: norbornene, alkyl- and/or alkylidene-substituted products thereof, such as 5-methyl-2-norbornene, 5-dimethyl-2-norbornene, 5-ethyl-2-norbornene, 5-butyl-2-norbornene, and 5-ethylidene-2-norbornene, and polar group- (such as halogen-) substituted products thereof; dicyclopentadiene and 2,3-dihydrodicyclopentadiene; dimethanooctahydronaphthalene, alkyl- and/or alkylidene-substituted products thereof, and polar group- (such as halogen-) substituted products thereof, such as 6-methyl-1,4:5,8-dimethano-1,4,4a,5,6,7,8,8α-octahydronaphthalene, 6-ethyl-1,4:5,8-dimethano-1,4,4a,5,6,7,8,8α-octahydronaphthalene, 6-ethylidene-1,4:5,8-dimethano-1,4,4a,5,6,7,8,8α-octahydronaphthalene, 6-chloro-1,4:5,8-dimethano-1,4,4a,5,6,7,8,8α-octahydronaphthalene, 6-cyano-1,4:5,8-dimethano-1,4,4a,5,6,7,8,8α-octahydronaphthalene, 6-pyridyl-1,4:5,8-dimethano-1,4,4a,5,6,7,8,8α-octahydronaphthalene, and 6-methoxycarbonyl-1,4:5,8-dimethano-1,4,4a,5,6,7,8,8α-octahydronaphthalene; and a trimer and a tetramer of cyclopentadiene, such as 4,9:5,8-dimethano-3a,4,4a,5,8,8a,9,9α-octahydro-1H-benzoindene and 4,11:5,10:6,9-trimethano-3a,4,4a,5,5a,6,9,9a,10,10a,11,11α-dodecahydro-1H-cyclopentaanthracene.

Various products are commercially available as the polynorbornene. Specific examples thereof include products available under the trade names “ZEONEX” and “ZEONOR” from Zeon Corporation, a product available under the trade name “Arton” from JSR Corporation, a product available under the trade name “TOPAS” from TICONA, and a product available under the trade name “APEL” from Mitsui Chemicals, Inc.

An aromatic polycarbonate is preferably used as the polycarbonate-based resin. The aromatic polycarbonate may be typically obtained by the reaction of a carbonate precursor substance with an aromatic diphenol compound. Specific examples of the carbonate precursor substance include phosgene, diphenols such as bischloroformate, diphenylcarbonate, di-p-tolylcarbonate, phenyl-p-tolylcarbonate, di-p-chlorophenylcarbonate, and dinaphthylcarbonate. Of those, phosgene and diphenylcarbonate are preferred. Specific examples of the aromatic diphenol compound include 2,2-bis(4-hydroxyphenyl)propane, 2,2-bis(4-hydroxy-3,5-dimethylphenyl)propane, bis(4-hydroxyphenyl)methane, 1,1-bis-(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane, and 1,1-bis(4-hydroxyphenyl)-3,3,5-trimethylcyclohexane. They may be used alone or in combination. Of those, 2,2-bis(4-hydroxyphenyl)propane, 1,1-bis(4-hydroxyphenyl)cyclohexane, and 1,1-bis(4-hydroxyphenyl)-3,3,5-trimethylcyclohexane are preferably used. 2,2-Bis(4-hydroxyphenyl)propane and 1,1-bis(4-hydroxyphenyl)-3,3,5-trimethylcyclohexane are particularly preferably used in combination.

Examples of the stretching method include lateral uniaxial stretching, fixed-end biaxial stretching, and sequential biaxial stretching. The fixed-end biaxial stretching is specifically, for example, a method involving stretching the polymer film in its short direction (lateral direction) while causing the film to run in its lengthwise direction. The method can be apparently the lateral uniaxial stretching. In addition, oblique stretching can be adopted. The adoption of the oblique stretching can provide an elongated stretched film having an alignment axis (slow axis) having a predetermined angle relative to its widthwise direction.

The stretched film has a thickness of typically from 5 μm to 80 μm, preferably from 15 μm to 60 μm, more preferably from 25 μm to 45 μm.

C. Transparent Conductive Film

The transparent conductive film includes a transparent base material and a transparent conductive layer arranged on at least one side of the transparent base material. The transparent conductive layer includes a metal nanowire or a metal mesh.

The total light transmittance of the transparent conductive film is preferably 80% or more, more preferably 85% or more, particularly preferably 90% or more. A transparent conductive film to be obtained can have a high total light transmittance by virtue of the presence of the transparent conductive layer including the metal nanowire or the metal mesh.

The surface resistance value of the transparent conductive film is preferably from 0.1 Ω/□ to 1,000 Ω/□, more preferably from 0.5 Ω/□ to 500 Ω/□, particularly preferably from 1 Ω/□ to 250 Ω/□. A transparent conductive film to be obtained can have a small surface resistance value by virtue of the presence of the transparent conductive layer including the metal nanowire or the metal mesh. In addition, when the transparent conductive layer including the metal nanowire is formed, with a small amount of the metal nanowire, the surface resistance value can be reduced as described above and hence excellent conductivity can be expressed. Accordingly, a transparent conductive film having a high light transmittance can be obtained.

C-1. Transparent Base Material

The in-plane retardation Re of the transparent base material is from 1 nm to 100 nm, preferably from 1 nm to 50 nm, more preferably from 1 nm to 10 nm, still more preferably from 1 nm to 5 nm, particularly preferably from 1 nm to 3 nm. The in-plane retardation Re of the transparent base material is preferably as small as possible. The use of the transparent base material having a small in-plane retardation can prevent depolarization in the transparent conductive film and suppress the output of reflected light.

The absolute value of the thickness direction retardation Rth of the transparent base material is 100 nm or less, preferably 75 nm or less, more preferably 50 nm or less, particularly preferably 10 nm or less, most preferably 5 nm or less. It should be noted that the thickness direction retardation Rth in this description refers to a thickness direction retardation value at 23° C. and a wavelength of 590 nm. The Rth is determined from the equation Rth=(nx−nz)×d, where nx represents a refractive index in the direction in which an in-plane refractive index becomes maximum (i.e., a slow axis direction), nz represents a thickness direction refractive index, and d (nm) represents the thickness of a film (e.g., the transparent base material).

The thickness of the transparent base material is preferably from 20 μm to 200 μm, more preferably from 30 μm to 150 μm. When the thickness falls within such range, a transparent base material having a small retardation can be obtained.

The total light transmittance of the transparent base material is preferably 80% or more, more preferably 85% or more, still more preferably 90% or more.

Any appropriate material is used as a material constituting the transparent base material. Specifically, for example, a polymer base material such as a film or a plastic base material is preferably used. This is because the smoothness of the transparent base material and its wettability to a composition for forming a transparent conductive layer (a metal nanowire dispersion liquid or a composition for forming a protective layer) become excellent, and its productivity can be significantly improved by continuous production with a roll. A material capable of expressing an in-plane retardation Re in the above-mentioned range is preferably used.

The material constituting the transparent base material is typically a polymer film using a thermoplastic resin as a main component. Examples of the thermoplastic resin include: cycloolefin-based resins such as polynorbornene; acrylic resins; and low-retardation polycarbonate resins. Of those, a cycloolefin-based resin or an acrylic resin is preferred. The use of such resin can provide a transparent base material having a small retardation. In addition, such resin is excellent in, for example, transparency, mechanical strength, thermal stability, and moisture barrier property. The thermoplastic resins may be used alone or in combination.

Specific examples of the polynorbornene are as described in the section B-2.

The acrylic resin refers to a resin having a repeating unit derived from a (meth)acrylate ((meth)acrylate unit) and/or a repeating unit derived from (meth)acrylic acid ((meth)acrylic acid unit). The acrylic resin may have a constituent unit derived from a derivative of a (meth)acrylate or (meth)acrylic acid.

In the acrylic resin, the total content of the (meth)acrylate unit, the (meth)acrylic acid unit, and the constituent unit derived from a derivative of a (meth)acrylate or (meth)acrylic acid is preferably 50 wt % or more, more preferably from 60 wt %, to 100 wt %, particularly preferably from 70 wt % to 90 wt % with respect to all constituent units constituting the acrylic resin. When the total content falls within such range, a transparent base material having a low retardation can be obtained.

The acrylic resin may have a ring structure on its main chain. The presence of the ring structure can increase the glass transition temperature of the acrylic resin while suppressing an increase in its retardation. Examples of the ring structure include a lactone ring structure, a glutaric anhydride structure, a glutarimide structure, an N-substituted maleimide structure, and a maleic anhydride structure.

The lactone ring structure can adopt any appropriate structure. The lactone ring structure is preferably a four- to eight-membered ring, more preferably a five-membered ring or a six-membered ring, still more preferably a six-membered ring. A six-membered lactone ring structure is, for example, a lactone ring structure represented by the following general formula (1).

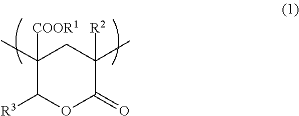

In the general formula (1), R¹, R², and R³ each independently represent a hydrogen atom, a linear or branched alkyl group having 1 to 20 carbon atoms, an unsaturated aliphatic hydrocarbon group having 1 to 20 carbon atoms, or an aromatic hydrocarbon group having 1 to 20 carbon atoms. The alkyl group, the unsaturated aliphatic hydrocarbon group, and the aromatic hydrocarbon group may each have a substituent such as a hydroxyl group, a carboxyl group, an ether group, or an ester group.

The glutaric anhydride structure is, for example, a glutaric anhydride structure represented by the following general formula (2). The glutaric anhydride structure can be obtained by, for example, subjecting a copolymer of a (meth)acrylate and (meth)acrylic acid to intramolecular dealcoholization cyclization condensation.

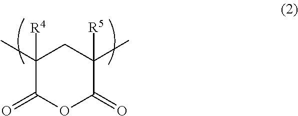

In the general formula (2), R⁴ and R⁵ each independently represent a hydrogen atom or a methyl group.

The glutarimide structure is, for example, a glutarimide structure represented by the following general formula (3). The glutarimide structure can be obtained by, for example, imidizing a (meth)acrylate polymer with an imidizing agent such as methylamine

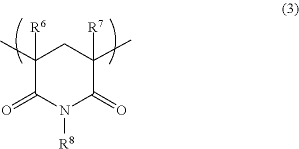

In the general formula (3), R⁶ and R⁷ each independently represent a hydrogen atom, or a linear or branched alkyl group having 1 to 8 carbon atoms, preferably a hydrogen atom or a methyl group. R⁸ represents a hydrogen atom, a linear alkyl group having 1 to 18 carbon atoms, a cycloalkyl group having 3 to 12 carbon atoms, or an aryl group having 6 to 10 carbon atoms, preferably a linear alkyl group having 1 to 6 carbon atoms, a cyclopentyl group, a cyclohexyl group, or a phenyl group.

In one embodiment, the acrylic resin has a glutarimide structure represented by the following general formula (4) and a methyl methacrylate unit.

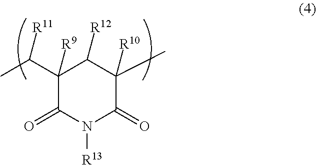

In the general formula (4), to R¹² each independently represent a hydrogen atom, or a linear or branched alkyl group having 1 to 8 carbon atoms. R represents a linear or branched alkyl group having 1 to 18 carbon atoms, a cycloalkyl group having 3 to 12 carbon atoms, or an aryl group having 6 to 10 carbon atoms.

The N-substituted maleimide structure is, for example, an N-substituted maleimide structure represented by the following general formula (5). An acrylic resin having the N-substituted maleimide structure on its main chain can be obtained by, for example, copolymerizing an N-substituted maleimide and a (meth)acrylate.

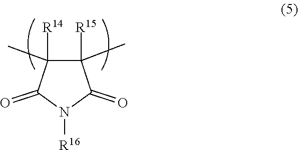

In the general formula (5), R¹⁴ and R¹⁵ each independently represent a hydrogen atom or a methyl group, and R¹⁶ represents a hydrogen atom, a linear alkyl group having 1 to 6 carbon atoms, a cyclopentyl group, a cyclohexyl group, or a phenyl group.

The maleic anhydride structure is, for example, a maleic anhydride structure represented by the following general formula (6). An acrylic resin having the maleic anhydride structure on its main chain can be obtained by, for example, copolymerizing maleic anhydride and a (meth)acrylate.

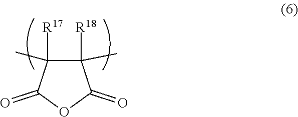

In the general formula (6), R¹⁷ and R¹⁸ each independently represent a hydrogen atom or a methyl group.

The acrylic resin may have any other constituent unit. Examples of the other constituent unit include constituent units derived from monomers such as styrene, vinyltoluene, α-methylstyrene, acrylonitrile, methyl vinyl ketone, ethylene, propylene, vinyl acetate, methallyl alcohol, allyl alcohol, 2-hydroxymethyl-1-butene, α-hydroxymethylstyrene, α-hydroxyethylstyrene, a 2-(hydroxyalkyl)acrylate such as methyl 2-(hydroxyethyl)acrylate, and a 2-(hydroxyalkyl)acrylic acid such as 2-(hydroxyethyl)acrylic acid.

in addition to the acrylic resins exemplified above, specific examples of the acrylic resin also include acrylic resins disclosed in JP 2004-168882 A, JP 2007-261265 A, JP 2007-262399 A, JP 2007-297615 A, JP 2009-039935 A, JP 2009-052021 A, and JP 2010-284840 A.

The glass transition temperature of the material constituting the transparent base material is preferably from 100° C. to 200° C., more preferably from 110° C. to 150° C., particularly preferably from 110° C. to 140° C. When the glass transition temperature falls within such range, a transparent conductive film excellent in heat resistance can be obtained.

The transparent base material may further contain any appropriate additive as required. Specific examples of the additive include a plasticizer, a heat stabilizer, a light stabilizer, a lubricant, an antioxidant, a UV absorber, a flame retardant, a coloring agent, an antistatic agent, a compatibilizer, a cross-linking agent, and a thickener. The kind and amount of the additive to be used may be appropriately set depending on purposes.

Any appropriate molding method is employed as a method of obtaining the transparent base material, and a proper method can be appropriately selected from, for example, a compression molding method, a transfer molding method, an injection molding method, an extrusion molding method, a blow molding method, a powder molding method, a FRP molding method, and a solvent casting method. Of those production methods, an extrusion molding method or a solvent casting method is preferably employed. This is because the smoothness of the transparent base material to be obtained is improved and hence good optical uniformity can be obtained. Molding conditions can be appropriately set depending on, for example, the composition and kind of the resin to be used.

The transparent base material maybe subjected to various surface treatments as required. Any appropriate method is adopted for such surface treatment depending on purposes. Examples thereof include a low-pressure plasma treatment, an ultraviolet irradiation treatment, a corona treatment, a flame treatment, and acid and alkali treatments. In one embodiment, the surface of the transparent base material is hydrophilized by subjecting the transparent base material to a surface treatment. When the transparent base material is hydrophilized, processability upon application of a composition for forming a transparent conductive layer (a metal nanowire dispersion liquid or a composition for forming a protective layer) prepared with an aqueous solvent becomes excellent. In addition, a transparent conductive film excellent in adhesiveness between the transparent base material and the transparent conductive layer can be obtained.

C-2. Transparent Conductive Layer

The transparent conductive layer includes a metal nanowire or a metal mesh.

(Metal Nanowire)

The metal nanowire refers to a conductive substance that uses a metal as a material, has a needle- or thread-like shape, and has a diameter of the order of nanometers. The metal nanowire may be linear or may be curved. When a transparent conductive layer including the metal nanowire is used, a transparent conductive film excellent in bending resistance can be obtained. In addition, when a transparent conductive layer including the metal nanowire is used, the metal nanowire is formed into a network shape. Accordingly, even when a small amount of the metal nanowire is used, a good electrical conduction path can be formed and hence a transparent conductive film having a small electrical resistance can be obtained. Further, the metal nanowire is formed into a network shape, and hence an opening portion is formed in a gap of the network. As a result, a transparent conductive film having a high light transmittance can be obtained.

A ratio (aspect ratio: L/d) between a thickness d and a length L of the metal nanowire is preferably from 10 to 100,000, more preferably from 50 to 100,000, particularly preferably from 100 to 10,000. When a metal nanowire having such large aspect ratio as described above is used, the metal nanowire satisfactorily intersects with itself and hence high conductivity can be expressed with a small amount of the metal nanowire. As a result, a transparent conductive film having a high light transmittance can be obtained. It should be noted that the term “thickness of the metal nanowire” as used herein has the following meanings: when a section of the metal nanowire has a circular shape, the term means the diameter of the circle; when the section has an elliptical shape, the term means the short diameter of the ellipse; and when the section has a polygonal shape, the term means the longest diagonal of the polygon. The thickness and length of the metal nanowire can be observed with a scanning electron microscope or a transmission electron microscope.

The thickness of the metal nanowire is preferably less than 500 nm, more preferably less than 200 nm, particularly preferably from 10 nm to 100 nm, most preferably from 10 nm to 50 nm. When the thickness falls within such range, a transparent conductive layer having a high light transmittance can be formed.

The length of the metal nanowire is preferably from 2.5 μm to 1,000 μm, more preferably from 10 μm to 500 μm, particularly preferably from 20 μm to 100 μm. When the length falls within such range, a transparent conductive film having high conductivity can be obtained.

Any appropriate metal can be used as a metal constituting the metal nanowire as long as the metal has high conductivity. The metal nanowire is preferably constituted of one or more kinds of metals selected from the group consisting of gold, platinum, silver, and copper. Of those, silver, copper, or gold is preferred from the viewpoint of conductivity, and silver is more preferred. In addition, a material obtained by subjecting the metal to metal plating (e.g., gold plating) may be used.

Any appropriate method can be adopted as a method of producing the metal nanowire. Examples thereof include: a method involving reducing silver nitrate in a solution; and a method involving causing an applied voltage or current to act on a precursor surface from the tip portion of a probe, drawing a metal nanowire at the tip portion of the probe, and continuously forming the metal nanowire. In the method involving reducing silver nitrate in the solution, a silver nanowire can be synthesized by performing the liquid-phase reduction of a silver salt such as silver nitrate in the presence of a polyol such as ethylene glycol and polyvinyl pyrrolidone. The mass production of a silver nanowire having a uniform size can be performed in conformity with a method described in, for example, Xia, Y. et al., Chem. Mater. (2002), 14, 4736-4745 or Xia, Y. et al., Nano letters (2003), 3 (37), 955-960.

The metal nanowire in the transparent conductive layer may be protected with a protective layer.

Any appropriate resin can be used as a material forming the protective layer. Examples of the resin include: an acrylic resin; a polyester-based resin such as polyethylene terephthalate; aromatic resins such as polystyrene, polyvinyltoluene, polyvinylxylene, polyimide, polyamide, and polyamide imide; a polyurethane-based resin; an epoxy-based resin; a polyolefin-based resin; an acrylonitrile-butadiene-styrene copolymer (ABS);

cellulose; a silicon-based resin; polyvinyl chloride; polyacetate; polynorbornene; a synthetic rubber; and a fluorine-based resin. Of those, a curable resin constituted of a polyfunctional acrylate (preferably a UV-curable resin) such as pentaerythritol triacrylate (PETA), neopentyl glycol diacrylate (NPGDA), dipentaerythritol hexaacrylate (DPHA), dipentaerythritol pentaacrylate (DPPA), or trimethylolpropane triacrylate (TMPTA) is preferably used.

The protective layer may be constituted of a conductive resin. Examples of the conductive resin include poly(3,4-ethylenedioxythiophene) (PEDOT), polyaniline, polythiophene, and polydiacetylene.

The protective layer may be constituted of an inorganic material. Examples of the inorganic material include silica, mullite, alumina, SiC, MgO—Al₂O₃—SiO₂, Al₂O₃—SiO₂, and MgO—Al₂O₃—SiO₂—Li₂O.

The transparent conductive layer can be formed by applying, onto the transparent base material, a dispersion liquid (metal nanowire dispersion liquid) obtained by dispersing the metal nanowire in a solvent, and then drying the applied layer.

Examples of the solvent to be incorporated into the metal nanowire dispersion liquid include water, an alcohol-based solvent, a ketone-based solvent, an ether-based solvent, a hydrocarbon-based solvent, and an aromatic solvent. Water is preferably used from the viewpoint of a reduction in environmental load.

The dispersion concentration of the metal nanowire in the metal nanowire dispersion liquid is preferably from 0.1 wt % to 1 wt %. When the dispersion concentration falls within such range, a transparent conductive layer excellent in conductivity and light transmittance can be formed.

The metal nanowire dispersion liquid may further contain any appropriate additive depending on purposes. Examples of the additive include an anticorrosive material for preventing the corrosion of the metal nanowire and a surfactant for preventing the agglomeration of the metal nanowire. The kinds, number, and amount of additives to be used can be appropriately set depending on purposes. In addition, the metal nanowire dispersion liquid may contain any appropriate binder resin as required as long as the effects of the present invention are obtained.

Any appropriate method can be adopted as an application method for the metal nanowire dispersion liquid. Examples of the application method include spray coating, bar coating, roll coating, die coating, inkjet coating, screen coating, dip coating, slot die coating, a relief printing method, an intaglio printing method, and a gravure printing method. Any appropriate drying method (such as natural drying, blast drying, or heat drying) can be adopted as a method of drying the applied layer. In the case of, for example, the heat drying, a drying temperature is typically from 100° C. to 200° C. and a drying time is typically from 1 minute to 10 minutes.

When the transparent conductive layer has a protective layer, the protective layer can be formed by, for example, forming a metal nanowire portion as described above, then further applying a composition for forming a protective layer containing the material for forming a protective layer or a precursor of the material for forming a protective layer (monomer constituting the resin), and then subjecting the composition to drying, and as required, a curing treatment. The same method as that of the dispersion liquid can be adopted as a method for the application. Any appropriate drying method (such as natural drying, blast drying, or heat drying) can be adopted as a method for the drying. In the case of, for example, the heat drying, a drying temperature is typically from 100° C. to 200° C. and a drying time is typically from 1 minute to 10 minutes. The curing treatment can be performed under any appropriate condition depending on the resin constituting the protective layer.

The composition for forming a protective layer may contain a solvent. Examples of the solvent to be incorporated into the composition for forming a protective layer include an alcohol-based solvent, a ketone-based solvent, tetrahydrofuran, a hydrocarbon-based solvent, and an aromatic solvent. The solvent is preferably volatile. The boiling point of the solvent is preferably 200° C. or less, more preferably 150° C. or less, still more preferably 100° C. or less.

The composition for forming a protective layer may further contain any appropriate additive depending on purposes. Examples of the additive include a cross-linking agent, a polymerization initiator, a stabilizer, a surfactant, and a corrosion inhibitor.

When the transparent conductive layer includes the metal nanowire, the thickness of the transparent conductive layer is preferably from 0.01 μm to 10 μm, more preferably from 0.05 μm to 3 μm, particularly preferably from 0.1 μm to 1 μm. When the thickness falls within such range, a transparent conductive film excellent in conductivity and light transmittance can be obtained.

When the transparent conductive layer includes the metal nanowire, the total light transmittance of the transparent conductive layer is preferably 85% or more, more preferably 90% or more, still more preferably 95% or more.

The content of the metal nanowire in the transparent conductive layer is preferably from 30 wt % to 96 wt %, more preferably from 43 wt % to 88 wt % with respect to the total weight of the transparent conductive layer. When the content falls within such range, a transparent conductive film excellent in conductivity and light transmittance can be obtained.

When the metal nanowire is a silver nanowire, the density of the transparent conductive layer is preferably from 1.3 g/cm³ to 7.4 g/cm³, more preferably from 1.6 g/cm³ to 4.8 g/cm³. When the density falls within such range, a transparent conductive film excellent in conductivity and light transmittance can be obtained.

(Metal Mesh)

The transparent conductive layer including the metal mesh is obtained by forming a thin metal wire into a lattice pattern on the transparent base material. The transparent conductive layer including the metal mesh can be formed by any appropriate method. The transparent conductive layer can be obtained by, for example, applying a photosensitive composition (composition for forming a transparent conductive layer) containing a silver salt onto the laminate, and then subjecting the resultant to an exposure treatment and a developing treatment to form the thin metal wire into a predetermined pattern. In addition, the transparent conductive layer can be obtained by printing a paste (composition for forming a transparent conductive layer) containing metal fine particles into a predetermined pattern. Details about such transparent conductive layer and a formation method therefor are described in, for example, JP 2012-18634 A, and the description is incorporated herein by reference. In addition, other examples of the transparent conductive layer including the metal mesh and the formation method therefor include a transparent conductive layer and a formation method therefor described in JP 2003-331654 A.

When the transparent conductive layer includes the metal mesh, the thickness of the transparent conductive layer is preferably from 0.1 μm to 30 μm, more preferably from 0.1 μm to 9 μm, still more preferably from 1 μm to 3 μm.

When the transparent conductive layer includes the metal mesh, the transmittance of the transparent conductive layer is preferably 80% or more, more preferably 85% or more, still more preferably 90% or more.

The transparent conductive layer may be patterned into a predetermined pattern. The shape of the pattern of the transparent conductive layer is preferably a pattern satisfactorily operating as a touch panel (such as a capacitance-type touch panel). Examples thereof include patterns described in JP 2011-511357 A, JP 2010-164938 A, JP 2008-310550 A, JP 2003-511799 A, and JP 2010-541109 A. After having been formed on the transparent base material, the transparent conductive layer can be patterned by employing a known method. In the present invention, the pattern of the transparent conductive layer patterned as described above can be prevented from being visually observed.

C-3. Other Layer

The transparent conductive film may include any appropriate other layer as required. Examples of the other layer include a hard coat layer, an antistatic layer, an antiglare layer, an antireflection layer, and a color filter layer.

The hard coat layer has a function of imparting chemical resistance, scratch resistance, and surface smoothness to the transparent base material.

Any appropriate material can be adopted as a material constituting the hard coat layer. Examples of the material constituting the hard coat layer include an epoxy-based resin, an acrylic resin, and a silicone-based resin, and a mixture thereof. Of those, an epoxy-based resin excellent in heat resistance is preferred. The hard coat layer can be obtained by curing any such resin with heat or an active energy ray.

### EXAMPLES

Now, the present invention is specifically described by way of Examples. However, the present invention is by no means limited to Examples described below. Evaluation methods in Examples are as described below. It should be noted that a thickness was measured with a Peacock Precision Measuring Instrument Digital Gauge Cordless Type “DG-205” manufactured by Ozaki Mfg Co., Ltd.

(1) Retardation Value

Measurement was performed with a product available under the trade name “KOBRA-WPR” from Oji Scientific Instruments. A measurement temperature was set to 23° C. and a measurement wavelength was set to 590 nm.

(2) Surface Resistance Value

Measurement was performed with a product available under the trade name “EC-80” from NAPSON. A measurement temperature was set to 23° C.

(3) Total Light Transmittance and Haze

Measurement was performed with a product available under the trade name “HR-100” from Murakami Color Research Laboratory Co., Ltd. at 23° C. The measurement was repeated three times and the average of the three values was defined as a measured value.

(4) Diffuse Reflectance

Measurement was performed with a product available under the trade name “CM-2600d” from Konica Minolta, Inc. under a D65 light source according to a Specular Component Exclude (SCE) mode. A measurement temperature was set to 23° C. The measurement was repeated twice and the average of the two values was defined as a measured value.

It should be noted that in Examples and Comparative Examples, a diffuse reflectance A measured by placing a laminate including a circularly polarizing plate and a transparent conductive film on a reflective plate made of aluminum, and a diffuse reflectance A′ measured after the removal of a metal nanowire from the transparent conductive film of the laminate were measured.

### Example 1

### (Production of Circularly Polarizing Plate)

A norbornene-based cycloolefin film (manufactured by Zeon Corporation, trade name: “ZEONOR”) was uniaxially stretched so as to have an in-plane retardation Re at a wavelength of 590 nm of 140 nm. Thus, a retardation film (λ/4 plate) was obtained. The thickness direction retardation Rth of the film was 65 nm.

The retardation film (λ/4 plate) and a linear polarizer (manufactured by Nitto Denko Corporation, trade name: “Polarizing Plate SEG1425”) including a pressure-sensitive adhesive layer were bonded to each other so that an angle formed between the slow axis of the retardation film (λ/4 plate) and the absorption axis of the linear polarizer became 45°. Thus, a circularly polarizing plate was obtained.

(Synthesis of Silver Nanowire and Preparation of Silver Nanowire Dispersion Liquid)

5 Milliliters of anhydrous ethylene glycol and 0.5 ml of a solution of PtCl₂ in anhydrous ethylene glycol (concentration: 1.5×10⁻⁴ mol/L) were added to a reaction vessel equipped with a stirring device under 160° C. After a lapse of 4 minutes, 2.5 ml of a solution of AgNO₃ in anhydrous ethylene glycol (concentration: 0.12 mol/l) and 5 ml of a solution of polyvinyl pyrrolidone (MW: 5,500) in anhydrous ethylene glycol (concentration: 0.36 mol/l) were simultaneously dropped to the resultant solution over 6 minutes to produce a silver nanowire. The dropping was performed under 160° C. until AgNO₃ was completely reduced. Next, acetone was added to the reaction mixture containing the silver nanowire obtained as described above until the volume of the reaction mixture became 5 times as large as that before the addition. After that, the reaction mixture was centrifuged (2,000 rpm, 20 minutes). Thus, a silver nanowire was obtained.

The resultant silver nanowire had a short diameter of from 30 nm to 40 nm, a long diameter of from 30 nm to 50 nm, and a length of from 30 μm to 50 μm.

A silver nanowire dispersion liquid was prepared by dispersing the silver nanowire (concentration: 0.2 wt %) and dodecyl-pentaethylene glycol (concentration: 0.1 wt %) in pure water.

(Preparation of Composition for forming Protective Layer)

A mixture containing isopropyl alcohol (manufactured by Wako Pure Chemical Industries, Ltd.) and diacetone alcohol (manufactured by Wako Pure Chemical industries, Ltd.) at a weight ratio of 1:1 was used as a solvent. A composition for forming a protective layer was prepared by loading 3.0 wt % of dipentaerythritol hexaacrylate (DPHA) (manufactured by Shin-Nakamura Chemical Co., Ltd., trade name: “A-DPH”) and 0.09 wt % of a photoreaction initiator (manufactured by Ciba Japan, product name: “IRGACURE 907”) into the solvent.

(Production of Transparent Conductive Film (1))

A norbornene-based cycloolefin film (manufactured by Zeon Corporation, trade name: “ZEONOR”, in-plane retardation Re=1.7 nm, thickness direction retardation Rth=1.8 nm) was used as a transparent base material.

The silver nanowire dispersion liquid was applied onto the transparent base material with a bar coater (manufactured by Dai-ichi Rika Co., Ltd., product name: “Bar Coater No. 10”), and was dried in a fan dryer at 120° C. for 2 minutes. After that, the composition for forming a protective layer was applied with a slot die so as to have a wet thickness of 4 μm, and was dried in a fan dryer at 120° C. for 2 minutes. Next, a protective layer was formed by irradiating the composition for forming a protective layer with UV light having an integrated illuminance of 1,400 mJ/cm² from a UV light irradiation apparatus (manufactured by Fusion UV Systems) to cure the composition. Thus, a transparent conductive film (1) [transparent base material/transparent conductive layer (including a metal nanowire and the protective layer)] was obtained.

The transparent conductive film (1) had a surface resistance value of 136 Ω/□, a total light transmittance of 91.1%, and a haze of 1.7%.

(Measurement of Diffuse Reflectance A₁)

The circularly polarizing plate and the transparent conductive film (1) were bonded to each other through intermediation of a translucent pressure-sensitive adhesive (manufactured by Nitto Denko Corporation, trade name: “CS9662”) to provide a laminate I. At this time, the bonding was performed so that the retardation film of the circularly polarizing plate and the transparent conductive layer of the transparent conductive film (1) faced each other. Further, the laminate I was placed on a reflective plate made of aluminum so that the circularly polarizing plate was arranged on an outer side (side which ambient light entered), and a diffuse reflectance A₁ was measured in accordance with the method described in the section (4). The result is shown in Table 2.

It should be noted that the diffuse reflectance B of the reflective plate made of aluminum alone was separately measured in accordance with the method described in the section (4). As a result, the diffuse reflectance B was 53.27%.

(Measurement of Diffuse Reflectance A₁′)

The metal nanowire was removed by subjecting the transparent conductive film (1) to an etching treatment. The etching treatment was performed by immersing the transparent conductive film (1) in an etchant heated to 40° C. (manufactured by Kanto Chemical Co., Inc., product name: “Mixed Acid A1 Etchant”) for 15 seconds. The film after the etching treatment had a surface resistance value above the measurement upper limit of the apparatus (1,500 Ω/□), a total light transmittance of 91.4%, and a haze of 1.4%.

The circularly polarizing plate and the film after the etching treatment were bonded to each other through intermediation of a translucent pressure-sensitive adhesive (manufactured by Nitto Denko Corporation, trade name: “CS9662”) to provide a laminate I′. At this time, the bonding was performed so that the retardation film of the circularly polarizing plate and the protective layer of the film after the etching treatment faced each other. Further, the laminate I′ was placed on a reflective plate made of aluminum (diffuse reflectance B: 53.27%) so that the circularly polarizing plate was arranged on an outer side, and a diffuse reflectance A₁′ was measured in accordance with the method described in the section (4). The result is shown in Table 2.

### Example 2

### (Production of Circularly Polarizing Plate)

A circularly polarizing plate was produced in the same manner as in Example 1.

(Production of Transparent Conductive Film)

A norbornene-based cycloolefin film (manufactured by Zeon Corporation, trade name: “ZEONOR”, in-plane retardation Re=1.7 nm, thickness direction retardation Rth=1.8 nm) was used as a transparent base material. The surface of the norbornene-based cycloolefin film was made hydrophilic by subjecting the surface to a corona treatment.

After that, a metal mesh (line width: 8.5 μm, lattice having a pitch of 300 μm) was formed on one surface of the norbornene-based cycloolefin film with a silver paste (manufactured by TOYOCHEM Co., Ltd., trade name: “RA FS 039”) by a screen printing method, and was sintered at 120° C. for 10 minutes. Thus, a transparent conductive film (2) [transparent base material/transparent conductive layer (including the metal mesh)] was obtained.

The transparent conductive film had a surface resistance value of 205 Ω/□, a total light transmittance of 88.0%, and a haze of 6.8%.

(Measurement of Diffuse Reflectance A₁)

A diffuse reflectance A₁ was measured in the same manner as in Example 1 except that the transparent conductive film (2) was used. The result is shown in Table 2.

(Measurement of Diffuse Reflectance A₁′)

The metal mesh was removed by subjecting the transparent conductive film (2) to an etching treatment. The etching treatment was performed by immersing the transparent conductive film in an etchant heated to 40° C. (manufactured by Kanto Chemical Co., Inc., product name: “Mixed Acid A1 Etchant”) for 15 seconds. The film after the etching treatment had a surface resistance value above the measurement upper limit of the apparatus (1,500 Ω/□), a total light transmittance of 92.4%, and a haze of 0.3%.

The diffuse reflectance A₁′ of the film after the etching treatment was measured in the same manner as in Example 1. The result is shown in Table 2.

### Comparative Example 1

A circularly polarizing plate and a transparent conductive film (1) were produced in the same manner as in Example 1, and a diffuse reflectance A₂ and a diffuse reflectance A₂′ were measured as described below.

### (Measurement of Diffuse Reflectance A₂)

The circularly polarizing plate and the transparent conductive film were bonded to each other through intermediation of a translucent pressure-sensitive adhesive (manufactured by Nitto Denko Corporation, trade name: “CS9662”) to provide a laminate i. At this time, the bonding was performed so that the polarizer of the circularly polarizing plate and the transparent base material of the transparent conductive film faced each other. Further, the laminate i was placed on a reflective plate made of aluminum (diffuse reflectance B: 53.27%) so that the transparent conductive film was arranged on an outer side, and a diffuse reflectance A₂ was measured in accordance with the method described in the section (4). The result is shown in Table 2.

### (Measurement of Diffuse Reflectance A₂′)

The metal nanowire was removed by subjecting the transparent conductive film to an etching treatment. The etching treatment was performed by immersing the transparent conductive film in an etchant heated to 40° C. (manufactured by Kanto Chemical Co., Inc., product name: “Mixed Acid A1 Etchant”) for 15 seconds.

The circularly polarizing plate and the film after the etching treatment were bonded to each other through intermediation of a translucent pressure-sensitive adhesive (manufactured by Nitto Denko Corporation, trade name: “CS9662”) to provide a laminate i′. At this time, the bonding was performed so that the polarizer of the circularly polarizing plate and the transparent base material of the film faced each other. Further, the laminate i′ was placed on a reflective plate made of aluminum (diffuse reflectance B: 53.27%) so that the film was arranged on an outer side, and a diffuse reflectance A₂′ was measured in accordance with the method described in the section (4). The result is shown in Table 2.

### Comparative Example 2

A circularly polarizing plate was produced in the same manner as in Example 1. In addition, a transparent conductive film (3) was produced in the same manner as in Example 1 except that a PET film (manufactured by Mitsubishi Plastics, Inc., trade name: “DIAFOIL T602”, in-plane retardation Re=1,862 nm, thickness direction retardation Rth=6,541 nm) was used as a transparent base material. A diffuse reflectance A₁ and a diffuse reflectance A₁′ were measured in the same manner as in Example 1 except that the circularly polarizing plate and the transparent conductive film (3) were used. The results are shown in Table 2.

### Comparative Example 3

A circularly polarizing plate was produced in the same manner as in Example 1. In addition, a transparent conductive film (3) was produced in the same manner as in Example 1 except that a PET film (manufactured by Mitsubishi Plastics, Inc., trade name: “DIAFOIL T602”, in-plane retardation Re=1,862 nm, thickness direction retardation Rth=6,541 nm) was used as a transparent base material. A diffuse reflectance A₂ and a diffuse reflectance A₂′ were measured in the same manner as in Comparative Example 1 except that the circularly polarizing plate and the transparent conductive film (3) were used. The results are shown in Table 2.

### Comparative Example 4

A circularly polarizing plate and a transparent conductive film (2) were produced in the same manner as in Example 2. A diffuse reflectance A₂ and a diffuse reflectance A₂′ were measured in the same manner as in Comparative Example 1 except that the circularly polarizing plate and the transparent conductive film (2) were used. The results are shown in Table 2.

### Reference Example 1

A circularly polarizing plate was produced in the same manner as in Example 1. The circularly polarizing plate was placed on a reflective plate made of aluminum (diffuse reflectance B: 53.27%) so that its polarizer was arranged on an outer side, and a diffuse reflectance C was measured in accordance with the method described in the section (4). The diffuse reflectance C was 1.07%.

Constructions subjected to the measurement of the diffuse reflectances A in Examples 1 and 2, and Comparative Examples 1 to 4 are summarized in Table 1.

TABLE 1

| Example 1 | | Comparative Example 1 | | Comparative Example 2 | | Comparative Example 3 | |
|---|---|---|---|---|---|---|---|
| Circularly | Polarizer | Transparent | Transparent | Circularly | Polarizer | Transparent | Transparent |
| polarizing | Retardation film | conductive | conductive | polarizing | Retardation film | conductive | conductive layer |
| plate | (λ/4 plate) | film (1) | layer (including | plate | (λ/4 plate) | film (3) | (including metal |
| | | | metal nanowire) | | | | nanowire) |
| | | | Transparent | | | | Transparent base |
| | | | base material | | | | material |
| | | | (Re = 1.7 nm) | | | | (Re = 1,862 nm) |
| Transparent | Transparent | Circularly | Polarizer | Transparent | Transparent | Circularly | Polarizer |
| conductive | conductive layer | polarizing | Retardation film | conductive | conductive layer | polarizing | Retardation film |
| film (1) | (including metal | plate | (λ/4 plate) | film (3) | (including metal | plate | (λ/4 plate) |
| | nanowire) | | | | nanowire) | | |
| | Transparent base | | | | Transparent base | | |
| | material | | | | material | | |
| | (Re = 1.7 nm) | | | | (Re = 1,862 nm) | | |

| | | | |
|---|---|---|---|
| Reflective plate | Reflective plate | Reflective plate | Reflective plate |

| | |
|---|---|
| Example 2 | Comparative Example 4 |

| | | | |
|---|---|---|---|
| Circularly | Polarizer | Transparent | Transparent |
| polarizing | Retardation film | conductive | conductive layer |
| plate | (λ/4 plate) | film (2) | (including |
| | | | metal mesh) |
| | | | Transparent |
| | | | base material |
| | | | (Re = 1.7 nm) |
| Transparent | Transparent | Circularly | Polarizer |
| conductive | conductive layer | polarizing | Retardation |
| film (2) | (including metal mesh) | plate | film |
| | Transparent base | | (λ/4 plate) |
| | material (Re = 1.7 nm) | | |

| | |
|---|---|
| Reflective plate | Reflective plate |

TABLE 2

| | | | Comparative | Comparative | Comparative | Comparative |
|---|---|---|---|---|---|---|
| | Example 1 | Example 2 | Example 1 | Example 2 | Example 3 | Example 4 |
| Diffuse | 1.21 | 1.23 | 1.28 | 13.26 | 1.28 | 1.84 |
| reflectance A (%) | | | | | | |
| Diffuse | 1.09 | 1.09 | 1.10 | 13.21 | 1.09 | 1.10 |
| reflectance A′ (%) | | | | | | |
| Diffuse | 0.12 | 0.14 | 0.18 | 0.05 | 0.19 | 0.74 |
| reflectance | | | | | | |
| A-Diffuse | | | | | | |
| reflectance A′ (%) | | | | | | |
| Diffuse | 0.14 | 0.16 | 0.21 | 12.19 | 0.21 | 0.77 |
| reflectance | | | | | | |
| A-Diffuse | | | | | | |
| reflectance C (%) | | | | | | |
| Diffuse | 0.023 | 0.023 | 0.024 | 0.249 | 0.024 | 0.035 |
| reflectance | | | | | | |
| A/Diffuse | | | | | | |
| reflectance B of | | | | | | |
| reflective plate | | | | | | |

The diffuse reflectances A₁ and A₂ are each represented as the diffuse reflectance A.
The diffuse reflectances A₁′ and A₂′ are each represented as the diffuse reflectance A′.

As is apparent from Table 2, the diffuse reflectance A is reduced by arranging a circularly polarizing plate and a conductive film in the stated order from a side which ambient light enters (viewer side). The conductive pattern (pattern of the metal nanowire) of the image display apparatus of the present invention adopting such construction is hardly visually observed because the intensity of ambient light reflected on the metal nanowire is weak, and a difference in light intensity between the ambient light reflected on the metal nanowire and ambient light reflected on a portion except the metal nanowire is small. In addition, the apparatus has high contrast because the apparatus is reduced in ambient light reflection.

### REFERENCE SIGNS LIST

1 metal nanowire

2 protective layer

10 circularly polarizing plate

11 retardation film

12 polarizer

20 transparent conductive film

21 transparent base material

22 transparent conductive layer

30 display element

100 image display apparatus

1. An image display apparatus, comprising a circularly polarizing plate, a transparent conductive film, and a display element comprising a reflector made of a metal in the stated order from a viewer side, wherein:
the transparent conductive film comprises a transparent base material and a transparent conductive layer arranged on at least one side of the transparent base material;
the transparent base material has an in-plane retardation Re of from 1 nm to 100 nm; and
the transparent conductive layer comprises a metal nanowire or a metal mesh.

2. The image display apparatus according to claim 1, wherein:
the circularly polarizing plate comprises a retardation film and a polarizer; and
the circularly polarizing plate is arranged so that the polarizer is on the viewer side.

3. The image display apparatus according to claim 1, wherein in a portion in the image display apparatus where the circularly polarizing plate and the transparent conductive film are laminated, a diffuse reflectance is reduced by 90% or more.

4. The image display apparatus according to claim 1, wherein the transparent conductive layer is patterned.

5. The image display apparatus according to claim 1, wherein the metal nanowire comprises one or more kinds of metals selected from the group consisting of gold, platinum, silver, and copper.
